(19) United States
(12) Patent Application Publication
(10) Pub. No.: US 2008/0314749 A1
(43) Pub. Date: Dec. 25, 2008

(54) Microelectronic Device with Magnetic Excitation Wires

(75) Inventors: Mark Thomas Johnson, Veldhoven (NL); Albert Hendrik Jan Immink, Eindhoven (NL); Marc Wilhelmus Gijsbert Ponjee, Tilburg (NL); Mirielle Ann Reijme, Utrecht (NL); Josephus Arnoldus Henricus Maria Kahlman, Tilburg (NL); Jeroen Hans Nieuwenhuis, Waalre (NL); Bart Michiel De Boer, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/159,465

(22) PCT Filed: Oct. 25, 2006
(86) PCT No.: PCT/IB06/53926

§ 371 Date: Jun. 27, 2008

(30) Foreign Application Priority Data
Jan. 4, 2006 (EP) 06100078.2

(51) Int. Cl. G01N 27/26

(52) U.S. Cl. 204/450; 204/600

(57) ABSTRACT

The invention relates to a microelectronic device (200), particularly a magnetic biosensor, comprising B/E-electrodes (21) that can generate a magnetic field (B) in a sample chamber (10). The device further comprises E-electrodes (23, 24) that can generate an electrical field (E) in the sample chamber (10) in cooperation with the B/E-electrodes (21). Thus the B/E-electrodes are used for two purposes. Electrical fields (E) in the sample chamber (10) may particularly be used for pumping and/or mixing of a fluid sample or for a stringency test of particle bindings.

The invention relates to a microelectronic device for manipulating a sample, particularly a microelectronic biosensor, comprising wires for the excitation of magnetic fields. Furthermore, it relates to the use of such a microelectronic device and to a method for the manipulation of a sample in a sample chamber.

From the WO 2005/010543 A1 and WO 2005/010542 A2 a microelectronic device is known which is used as a microfluidic biosensor for the detection of biological molecules labeled with magnetic beads. The device is provided with an array of sensor units comprising wires for the generation of a magnetic field and Giant Magneto Resistance devices (GMRs) for the detection of stray fields generated by magnetized beads. The resistance of the GMRs is then indicative of the number of the beads near the sensor unit.

A microsensor device of the aforementioned kind typically needs means for initiating, assisting, and controlling the movement of investigated fluids in order to exchange samples and/or to accelerate diffusion processes. Such a manipulation of fluid flow can be achieved by using the generated magnetic fields additionally for moving the magnetic beads. This approach implies however a relatively large energy consumption due to long durations of the manipulation. Moreover, it is hard to achieve repulsive forces with magnetic fields. An alternative method to move a sample fluid or move particles in a fluid is based on electrical fields that couple to ions or particles within the fluid. A disadvantage of this approach is however that it requires additional electrodes making the design of the microelectronic device more complicated.

From the US 2004/0219695 A1 it is further known to use magnetic or electric fields for attracting molecules labeled with magnetically or electrically interactive particles to binding sites and/or for removing unbound labeled molecules from a sensor region. The document does however not describe how the fields are generated.

Based on this situation, it was an object of the present invention to provide means for an efficient manipulation of a sample that shall be subjected to magnetic fields in a microelectronic device.

This objective is achieved by a microelectronic device according to claim 1, by a method according to claim 19, and by a use according to claim 22. Preferred embodiments are disclosed in the dependent claims.

The microelectronic device according to the present invention is intended for the manipulation of a sample, particularly a liquid or gaseous chemical substance like a biological body fluid which may contain particles. The term “manipulation” shall denote any interaction with said sample, for example measuring characteristic quantities of the sample, investigating its properties, processing it mechanically or chemically or the like. The microelectronic device comprises the following components:

a) A sample chamber in which the sample to be manipulated can be provided. The sample chamber is typically an empty cavity or a cavity filled with some substance like a gel that may absorb a sample substance.
b) At least one (first) electrode. Because this electrode will be used for the generation of magnetic fields B and electrical fields E, it will be called “B/E-electrode” in the following.
c) A control circuit that is coupled to the B/E-electrode and that is adapted to control it selectively in two modes, namely in
(i) a “magnetizing mode” in which the B/E-electrode generates a magnetic field in the sample chamber, and
(ii) an “electrical mode” in which the B/E-electrode generates an electrical field in the sample chamber. In this context, the existence of a “magnetic or electrical field in the sample chamber” is assumed (i) if such a field exists at least in a sub region of the sample chamber, and (ii) if it is strong enough there to provoke desired/observable reactions of the sample to be manipulated. This definition shall exclude small “parasitic” magnetic or electrical fields that are inevitably associated with any (moving) electrical charge in the electrodes. Typically, the strength of magnetic fields in the sense of the present invention is in the order of 1-10 kA/m (depending on the distance from the electrode; it can be simply calculated from H=I/2πr, with H being the magnetic field around the electrode, r the distance from the electrode, and I the current through the electrode). The strength of electrical fields in the sense of the present invention is in the order of 1.000-1.000.000 V/m (assuming for the latter case wires at a distance of 3 μm driven with a voltage of 3 V). The magnetic and the electrical field may both be static or dynamic. Moreover, the “magnetizing mode” and the “electrical mode” may optionally be active simultaneously, sequentially, and/or in connection with further modes (e.g. a state in which the B/E-electrode is switched-off).

The microelectronic device may optionally further comprise

d) At least one second electrode. Because this electrode will be used for the generation of electrical fields, it will be called “E-electrode” in the following. The E-electrode servers as a counter electrode for the B/E-electrode in the “electrical mode”, i.e. the B/E-electrode generates in cooperation with the E-electrode an electrical field in the sample chamber.

The described microelectronic device has the advantage that the B/E-electrodes are not only used for generating magnetic fields in the sample chamber, but also for generating electrical fields. This allows an exploitation of both magnetic and electrical effects with a minimal amount of hardware.

While the B/E-electrode and the E-electrode may in general be electrical conductors of any material and shape, it is preferred that they are formed by conductor wires on a substrate. In this context, the term “wire” shall denote as usual an elongated object with for example elliptical or rectangular cross section. Typically, the conductor wires consist of a metal like aluminum or copper. The substrate is typically an insulating substrate such as a glass or plastic substrate or optionally a semiconductor material like silicon with one or more insulating layers.

According to a particular embodiment of the invention, the microelectronic device comprises at least one magnetic sensor element for detecting magnetic fields originating in the sample chamber, e.g. magnetic stray fields of magnetized beads that are generated in reaction to the magnetic field of the B/E-electrode. The magnetic sensor element may particularly be realized by a Hall sensor or a magneto-resistive element, for example a Giant Magnetic Resistance (GMR) element, a TMR (Tunnel Magneto Resistance) element, or an AMR (Anisotropic Magneto Resistance) element. Moreover, the B/E-electrodes, the E-electrodes, and the magnetic sensor element may be realized as an integrated circuit, for example using CMOS technology together with additional steps for realizing the magneto-resistive components on top of a CMOS circuitry. Alternatively, the B/E-electrodes, the E-electrodes, and the magnetic sensor element may be realized as an integrated device, for example using large area electronics technology together with additional steps for realizing the magneto-resistive components on top of a large area electronics substrate. Large area electronics, and specifically active matrix technology using for example Thin Film Transistors (TFT), is commonly used in the field of flat panel displays for the drive of many display effects e.g. LCD, OLED and Electrophoretic. The large area electronics device is suited to be manufactured using Low Temperature Poly-Silicon (LTPS) Thin Film Transistors. In particular, the device may be manufactured on a large area glass substrate using LTPS technology, since LTPS is particularly cost effective when used for large areas. Further known technologies used in large area electronics devices are amorphous-Si thin film transistor, microcrystalline or nano-crystalline Si, high temperature poly SiTFT, other anorganic TFTs based upon e.g. CdSe, SnO or organic TFTs. Similarly, MIM, i.e. metal-insulator-metal devices or diode devices, for example using the double diode with reset (D2R) active matrix addressing methods, as known in the art, may be used to develop the invention disclosed herein as well. The integrated circuit or large area electronics device may optionally also comprise the control circuits of the microelectronic device.

The microelectronic device and its control circuit may optionally be designed such that the magnetizing mode and the electrical mode may be executed simultaneously. This means that the B/E-electrode can at the same time generate a magnetic field and, alone or together with the E-electrode, an electrical field in the sample chamber. Alternatively, the microelectronic device may be designed such that the magnetizing mode and the electrical mode always exclude each other, i.e. that they may only be executed one after the other. Furthermore, a mixed design is possible in which some B/E-electrodes may be simultaneously operated in a magnetizing mode and an electrical mode while others may not.

The electrical field and/or the magnetic field may be homogeneous inside the sample chamber. It is however preferred that they have a non-zero gradient everywhere or at least somewhere inside the sample chamber, because such a gradient allows to exert forces on particles having a magnetic or electrical moment but no overall magnetic or electrical charge.

While in general the electrical field that is generated in the electrical mode may be used for any purpose, the microelectronic device is preferably designed such that this electrical field is capable (i.e. strong enough, properly directed and/or sufficiently inhomogeneous) of inducing a flow in a fluid or a motion of particles in a fluid in the sample chamber. Such a flow may particularly be induced by the interaction of the electrical field with ions in the fluid.

According to a preferred embodiment of the microelectronic device, the E-electrode may also be operated as a B/E-electrode. This means that there is a further magnetizing mode of the control circuit in which the E-electrode is operated such that it generates a magnetic field in the sample chamber. In a microelectronic device of this kind, both electrodes can generate magnetic fields as well as electrical fields in the sample chamber and thus provide a maximal functionality. In a preferred embodiment of such a microelectronic device, all E-electrodes are designed such that they can also be operated as B/E-electrode; with other words all electrodes are in fact only B/E-electrodes.

In another embodiment of the invention, the microelectronic device comprises an array of processing units, wherein each processing unit comprises at least one B/E-electrode. The processing units may for example be sensor units for measuring a characteristic quantity of a sample in the sample chamber. The processing units may further be substantially identical with respect to their electronic hardware, while they may well differ in features related to the chemistry of the sample to be manipulated. Thus the interfaces of the processing units with the sample chamber may be coated with different binding molecules for being sensitive to different chemical components of a sample fluid.

In a further development of the aforementioned embodiment, the B/E-electrodes of the processing units may also serve as E-electrodes. This means that they can also operate as counteracting electrode for a B/E-electrode in some other processing unit (typically a neighboring processing unit) when this is operated in its electrical mode. Thus microelectronic devices of identical or similar processing units in which all electrodes can generate magnetic fields (i.e. all electrodes are B/E-electrodes) may experience a considerable extension of functionality by optionally using electrodes also for the cooperative generation of electrical fields in the sample chamber.

The control circuit may be realized in many different ways, wherein the best choice typically depends on the boundary conditions of the specific application. In a preferred embodiment, the control circuit comprises at least one switch for selectively coupling the B/E-electrode to different power supplies. These supplies may for instance comprise a current source (typically used for generating a magnetic field in the magnetizing mode) and a voltage source (typically used for generating an electrical field in the electrical mode in cooperation with an E-electrode to which the other pole of the voltage source is coupled).

In another embodiment of the invention, the B/E-electrode and a dummy resistance are connected with one of their ends in parallel to one terminal of a current source. Moreover, the control circuit comprises at least one switch for selectively coupling the other terminal of the current source to the other end of the B/E-electrode or the dummy resistance, thus closing the circuit to the current source alternatively via the B/E-electrode or the dummy resistance. Closing the circuit via the B/E-electrode is then typically used for generating a magnetic field in the magnetizing mode, while closing the circuit via the dummy resistance is typically used for generating an electrical field in the electrical mode.

It was already mentioned that the microelectronic device may comprise only E-electrodes which can also be operated as B/E-electrode. In an alternative embodiment of the invention, the microelectronic device comprises at least one E-electrode that cannot be operated as a B/E-electrode. As no magnetic fields have to be generated with said “pure E-electrode”, it can be designed and located optimally with respect to the generation of desired electrical fields.

In a further development of the invention, particularly of its aforementioned embodiment, the microelectronic device comprises at least two additional E-electrodes, wherein the control circuit is adapted to control these additional E-electrodes in an “additional electrical mode” such that they generate cooperatively an electrical field in the sample chamber. This means that an additional electrical field can be generated in the sample chamber without making use of the B/E-electrode(s).

According to another variant of the invention, the sample chamber comprises a buffer region that is substantially out of the reach of the magnetic fields generated by the B/E-electrode in the sample chamber. Such a buffer region may be used to store a magnetically interactive substance which shall not be affected by said magnetic fields. Thus magnetizing beads can for example be provided in dry-form (solid phase) during the preparation of a biosensor for portable applications.

The aforementioned embodiment may further be provided with additional electrodes for generating an electrical field in the buffer region, wherein this generation may be achieved by said additional electrodes alone and/or in cooperation with the B/E-electrode(s) of the device. By generating electrical fields in the buffer region, a sample that is located there may selectively be manipulated.

In a preferred embodiment of the microelectronic device, the distance between the B/E-electrode and the E-electrode and/or between several E-electrodes is less than 200 μm, preferably less than 50 μm. These distances are in the same order of magnitude as typical distances between electrodes on a microelectronic device for magnetic sensing, which has the advantage that electrical fields of a certain strength can be generated with small voltages. Typical distances between wires on a GMR sensor chip are 10 μm, but may be smaller than 1 μm.

The B/E-electrode and/or the E-electrode are optionally separated from the sample chamber by a dielectric layer, for example a layer consisting of anorganic insulators such as silicon oxide or silicon nitride, organic insulators such as polyimide or photoresist layers (such as SU8).

The microelectronic device may further comprise a receiver (e.g. an antenna and associated circuits) for a wireless power supply, making the device particularly apt for portable applications.

The invention further relates to a method for the manipulation of a sample in a sample chamber, wherein the sample may comprise a fluid, preferably a fluid with particles. The method comprises the following steps:

a) The generation of a magnetic field in the sample chamber by applying a current to at least one (first) electrode (called “B/E-electrode”).
b) The generation of an electrical field in the sample chamber by applying an electrical potential to said B/E-electrode. Preferably a voltage (i.e. a potential difference) is applied between the B/E-electrode and a second electrode (called “E-electrode”).

The method comprises in general form the steps that can be executed with a microelectronic device of the kind described above. Therefore, reference is made to the preceding description for more information on the details, advantages and improvements of that method.

The invention further relates to the use of the microelectronic device described above for molecular diagnostics, biological sample analysis, or chemical sample analysis. Molecular diagnostics may for example be accomplished with the help of magnetic beads that are directly or indirectly attached to target molecules.

These and other aspects of the invention will be apparent from and elucidated with reference to the embodiment(s) described hereinafter. These embodiments will be described by way of example with the help of the accompanying drawings in which:

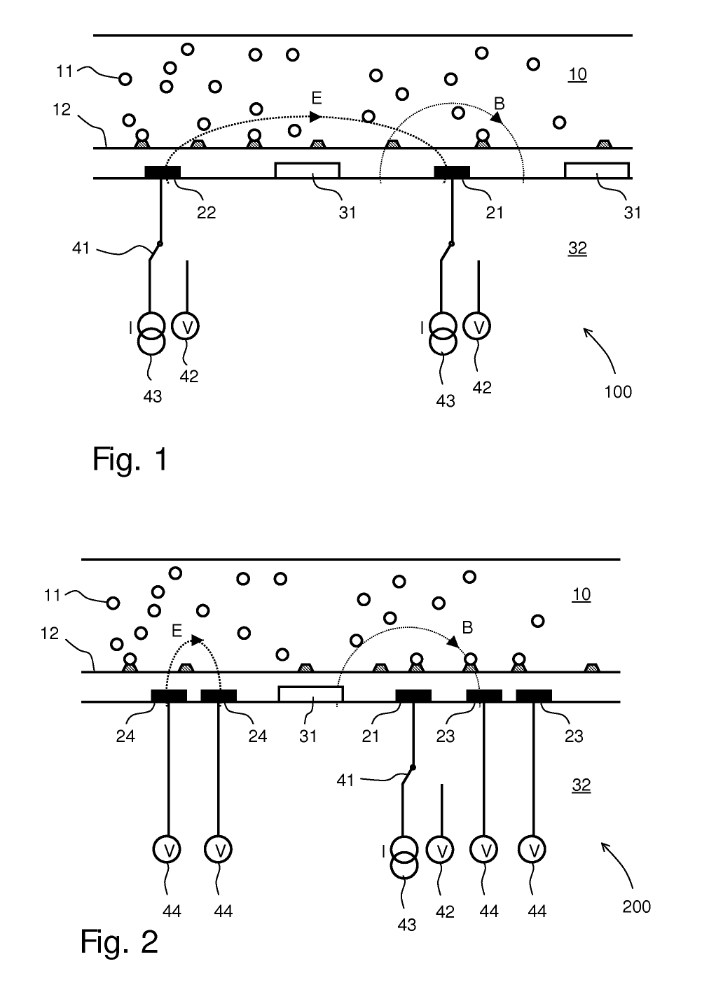

FIG. 1 shows a schematic cross section through two sensor units of a microelectronic magnetic biosensor according to a first embodiment of the present invention, wherein the same wires are used both as B/E-electrode and E-electrode;

FIG. 2 shows a schematic cross section through one sensor unit of a microelectronic magnetic biosensor according to a second embodiment of the invention, wherein additional wires are provided that serve only as E-electrodes;

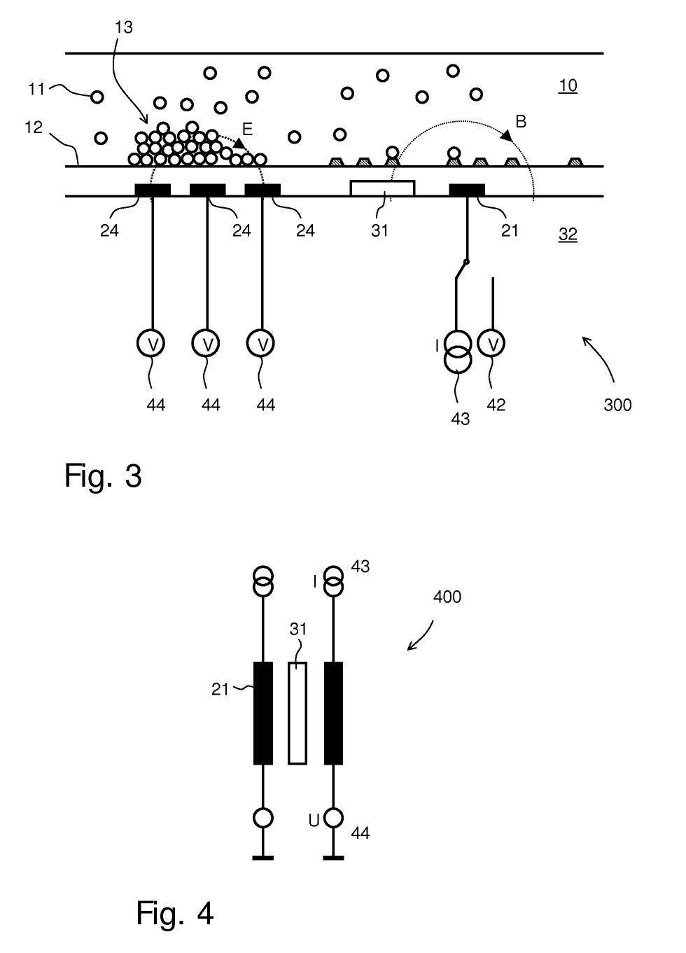

FIG. 3 shows a schematic cross section through one sensor unit of a microelectronic magnetic biosensor according to a third embodiment of the invention, wherein a buffer region and associated additional E-electrodes are provided;

FIG. 4 shows a layout of one sensor unit of a microelectronic magnetic biosensor according to a fourth embodiment of the invention, wherein magnetic excitation wires are connected to both a current source and a voltage source for a simultaneous generation of magnetic and electrical fields;

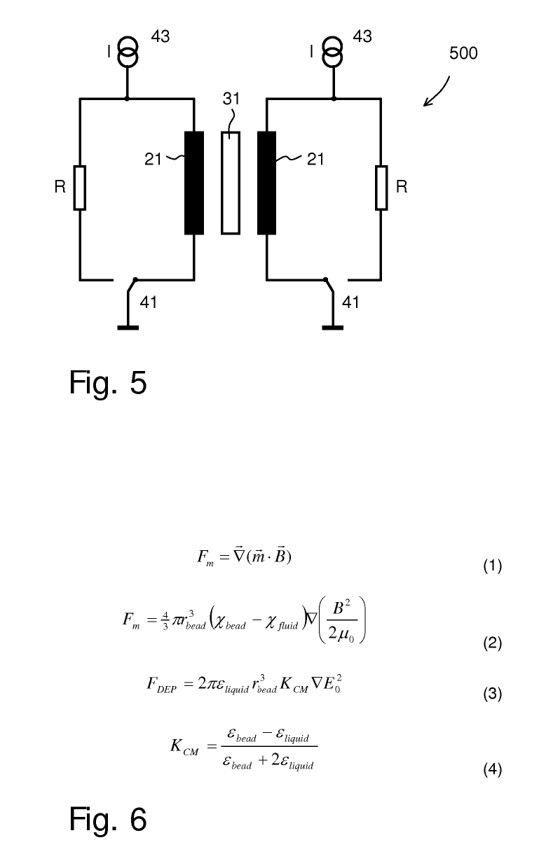

FIG. 5 shows a layout of one sensor unit of a microelectronic magnetic biosensor according to a fifth embodiment of the invention, wherein circuits comprising a current source are alternatively closed via a magnetic excitation wire or a dummy resistance;

FIG. 6 shows equations relating to the effect of field gradients.

Like reference numbers in the Figures refer to identical or similar components.

The Figures illustrate microelectronic devices according to the present invention in the particular application as magnetic biosensors for the detection of magnetically interactive particles, e.g. superparamagnetic beads, in a sample chamber. Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

The applications of magnetic biosensors comprise inter alia the analysis of blood (for e.g. proteins) and saliva (for e.g. drugs abuse). In all cases, the analysis begins with a period of labeling of target molecules with coated magnetic beads and capture of the molecules onto a capture selective surface. This process may take up to around one hour to maximize the number of captured molecules. The next important assay step is usually the so-called stringency step, in which a distinction is made between signals due to weak and due to strong biochemical binding. In such a step, the bound materials are put under stress to test the bindings for their strength and specificity. Unwanted magnetic beads which are not captured but are randomly positioned close to the surface are removed in this step from the surface (this requires a shorter time period in the order of less than one minute) before the magnetic detection of the captured molecules is carried out (required time period: <<1 sec).

There is a strong desire to increase the speed of the aforementioned process, particularly the capture period which is a diffusion limited process. As such, the rate can be increased by introducing some additional motion to the molecules. While the use of macroscopic flow of fluid may be suitable for a bench-top set up where larger amounts of fluid may be used, this is less suitable for a smaller, portable device. Furthermore, the removal of uncaptured magnetic beads during the stringency step can be realized by washing these away with yet another flowing fluid. This is however not easily transferred to a rapid and cost-effective biosensor, because the method requires a washing solution and mechanical pumping or valving.

In situations where little fluid is available (e.g. saliva analysis), there have been proposals to introduce additional particle motion by a magnetic pumping of the particles. Here, the wires that are used to create the magnetic field in a magnetic biosensor are activated during the capture process to move the magnetic particles to the capture surface (hence increasing the capture rate), and then to remove uncaptured magnetic particles. One problem with using a magnetic field for capture and removal is however that creating a magnetic field is very power consuming. Whilst this is not an issue during sensing (as this process is of very short duration), it becomes a major issue for the far longer capture and removal phases. In particular, magnetic pumping is not preferred for portable applications, and may be completely unsuitable if the (portable) application needs to access its power in a wireless system. Another problem with using magnetic fields is that repulsive forces are very difficult to achieve.

In order to address the mentioned problems, it is proposed here to re-use the wiring used to create the magnetic field in a magnetic biosensor in order to realize a non-magnetic function within the biosensor. In the embodiments of this idea that will be described first, this function comprises a pumping function, based upon an electric field induced flow of the fluid or of particles in the fluid to be analyzed. The advantage of electrical pumping as compared to magnetic pumping is the lower power dissipation, making this solution particularly attractive for a portable application, such as a roadside drug test.

Furthermore in the case of electrical pumping of the fluid this would offer more flow as the concentration of ionic particles is larger than the concentration of magnetic beads. Besides the flow, the field direction of motion vectors can be controlled more accurately. For instance, with electrical pumping a circular flow can be created, while magnetic pumping will result mainly in moving up and down.

FIG. 1 shows a first embodiment of a microelectronic biosensor 100 that incorporates the aforementioned principles. The biosensor 100 typically consists of an array of (e.g. 100) sensor units, of which only two are depicted in FIG. 1. The biosensor 100 may be used to simultaneously measure the concentration of a large number of different biological or synthesized target molecules (e.g. protein, DNA, amino acids, drugs) in a solution (e.g. blood, saliva or urine). In one possible example of a binding scheme, the so-called “sandwich assay”, this is achieved by providing a capture surface 12 with first antibodies, to which the target molecules may bind. Superparamagnetic beads 11 carrying second antibodies may then attach to the bound target molecules. Superparamagnetic beads 11 are also denoted as magnetic particles in the following. A current flowing in a wire 21, 22 (“B/E-electrode”) of a sensor unit generates a magnetic field B in the adjacent part of a sample chamber 10 and magnetizes the superparamagnetic beads 11 therein. The stray field from these super-paramagnetic beads 11 (not shown) introduces a magnetization component in the Giant Magneto Resistance (GMR) 31 of the sensor unit that generates a measurable resistance change. This method is also applicable to other binding schemes (e.g. inhibition or competitive assays) to detect small molecules like drugs.

The wires 21, 22 are preferably situated close to the liquid in the sample chamber 10, but separated from it by a thin dielectric layer. Normally, a continuous current (either DC or AC) is passed through the wires 21, 22 by a current source 43 in a “magnetizing mode” to create the magnetic field B. Such a continuous current causes considerable power dissipation. The wires 21, 22 are therefore re-used to create an electric field E in the sample chamber 10. In order to create such an electric field E, it is necessary that at least two separated electrodes are present. In the first embodiment of the invention shown in FIG. 1, this is achieved by the plurality of sensing units, each of which contains a wire 21, 22 which can take the role of one of the at least two electrodes in an “electrical mode”. This can be realized by e.g. disconnecting at least two wires from an associated controlled current source 43 and connecting them to an associated voltage source 42. In this manner, the desired electric field E is created. The switching can for example be implemented using transistor switches 41.

Whilst the electric field E could be used for many purposes (e.g. sensing various properties of the sample), it is preferably used to create an additional movement of the magnetic particles 11. There are many known methods of moving particles in a fluid using an applied electric field, for example:
in electrophoretic systems, charged particles move directly under the influence of DC fields;
in di-electrophoretic systems, un-charged (but polarizable) particles move directly under the influence of AC fields;
in electro-osmosis and electro-hydrodynamics systems, any particles move indirectly under the influence of fluid motion set up by the motion of ionic species in the liquid when electric fields are present.

In all these cases (and many others), the particle motion is realized simply by the presence of the electric field. Creating an electric field requires only enough energy to charge up the capacitance between the electrodes, whilst maintaining the field requires only that any leakage current between the electrodes is replaced. Both situations represent a major saving in power compared to creating a magnetic field. In a preferred embodiment of the invention an electrical field pumping is therefore used for both the capture and removal processes. The wires 21, 22 only revert to a magnetic field generating function (by connecting them to their separate current sources 43 in the “magnetizing mode”) during the extremely short period of magnetic sensing.

The described embodiment operates with an acceptably low power consumption whilst providing the required faster analysis required for a portable device. In a preferred embodiment, the device may further comprise methods to access the required power in a wireless manner from an external device.

The position and/or number of wires present in the standard magnetic biosensor may be insufficient to provide the required particle motion. The second embodiment of a magnetic biosensor 200 shown in FIG. 2 therefore comprises more than one wire in each sensor unit. The additional wires 23, 24 preferably have dedicated functions as additional electrodes, and may be connected directly to voltage sources 44. These electrodes 23, 24 can be used as a second electrode to make electric field induced particle motion possible in a biosensor with a single magnetic sensing unit. Alternatively, the additional electrodes 23, 24 could be used to induce desired electric field patterns or field strengths to enhance the motion of the particles. For example, providing more electrodes at a distance closer together than the standard wires may enable a desired particle motion with a smaller voltage (as electric field=voltage/separation). This may result in a still further power saving in this device.

FIG. 3 shows a third embodiment of a magnetic biosensor 300 which has extra electrodes 24 to enhance dissolution of a buffer of magnetic particles. Said extra electrodes 24 are disposed at a location different than nearby the magnetic sensing unit(s) 31, but in the same compartment as the magnetic sensing unit(s), to electrically induce particle motion.

In all cases analysis of bodily fluids (e.g. blood, saliva, etc.) using a magnetic biosensor starts with adding (coated) magnetic particles to the sample. In portable applications, preferably a buffer 13 (or a plurality of buffers) of magnetic particles in dry-form (solid phase) is already present in the compartment containing the magnetic sensing unit(s) before the fluid is inserted. As a first step towards analysis, this buffer 13 of magnetic particles needs to be dissolved in, and mixed with, the fluid under test. Typically, the buffer of magnetic particles is not positioned near the magnetic sensing unit(s) 31, as non-dissolved parts would interfere with the monitoring of the magnetic signal of captured particles.

Therefore, it is proposed here to use extra electrodes, such as the mentioned extra electrodes 24 located near (e.g. underneath) the buffer 13 of magnetic particles, to enhance dissolution of the buffer of magnetic particles in the fluid using electrically induced particle motion. Analogously, extra electrodes can be used to enhance mixing of the magnetic particles and fluid by electrical pumping in a certain area of the compartment, other than near the magnetic sensing unit(s).

FIG. 4 shows a layout of one sensor unit of a microelectronic magnetic biosensor 400 according to a fourth embodiment of the invention. The sensor unit comprises two parallel magnetic excitation wires serving as B/E-electrodes 21 between which a GMR sensor 31 is located. Each wire 21 is connected to both a current source 43 and a voltage source 44. Thus it is possible to generate simultaneously magnetic and electrical fields, i.e. to operate simultaneously in a “magnetizing mode” and an “electrical mode”.

FIG. 5 shows the layout of one sensor unit of a magnetic biosensor 500 according to a fifth embodiment of the invention. The sensor unit comprises again two parallel magnetic excitation wires serving as B/E-electrodes 21 between which a GMR sensor 31 is located. Each wire 21 is connected with one end to a different current source 43. In the shown state, the circuit via each wire 21 is closed by connecting its other end with a switch 41 to ground. The wires 21 therefore generate a magnetic field, i.e. they operate in their “magnetizing mode”. If the switches 41 are toggled, the circuits from the current sources 43 to ground are closed via dummy resistances R (e.g. of 10 ohm) instead of the wires 21. This allows to generate a voltage difference between the (current-free) wires 21 and thus the generation of an electrical field, i.e. the wires operate in their “electrical mode”.

In the description of the previous Figures it was exemplarily assumed that the generated electrical fields act on electrically charged particles, e.g. on ions. As the following general discussion shows, it is however also possible to exert forces on particles that are as a whole electrically (and/or magnetically) neutral.

A current going through a simple wire creates a magnetic field that has a strong gradient that is directed towards the wire. The attractive force Fm due to the presence of a magnetic field gradient on a super-paramagnetic bead is given by equation (1) of FIG. 6, where m is the magnetic moment of the bead and B is the magnetic induction. For a super-paramagnetic bead this force can be expressed by equation (2), where r_{bead} is the radius of the magnetic bead, χ_{bead} and χ_{fluid} are the bulk susceptibilities of the bead material and the fluid, respectively. As the susceptibility of magnetic beads is typically much higher than the susceptibility of water, beads can be attracted fairly easily using magnetic field gradients. However, magnetic repulsion is very difficult.

To generate a strong electric field gradient typically two conductors are needed, where a potential difference is applied between the two. The force F_{DEP} as a consequence of a strong electric field (for sufficiently high frequencies) can be expressed by equations (3) and (4), where ∈_{liquid} and ∈_{bead} are the permittivities of the liquid and bead, respectively, and E₀ is the electrical field strength. As ∈_{liquid} is typically larger than ∈_{bead}, repulsion of the beads can be realized using electric field gradients (dielectrophoresis). Attraction with dielectrophoresis is however hardly possible in water.

The dilemma that turned out in the above analysis can be solved if magnetic forces are used for attraction and electrical forces are used for repulsion of magnetic beads. In general, elongated conductors can be used for attraction of beads by forcing a current through them, and repulsion of the beads can be realized with the same conductors, by applying a potential difference over the same two conductors without having a current flowing. Particularly suited are the described embodiments of the magnetic sensor, wherein on-chip combined electro- and magnetic bead excitation is used by actuating the beads by a magnetic field gradient and/or an electrical field gradient, and wherein said gradients are optionally induced by the same existing excitation wire(s) that are used for detection of the beads.

The attraction, repulsion and movement of magnetic beads across a sensor surface can particularly be done to wash away non-specific and un-bonded materials, e.g. target molecules, labels and beads. It is the shear forces, the collisions with the surface, and the non-specific interactions between washing-beads and moving fluid and the surface that put the bound material under stringency. This method therefore realizes liquid flow, impact from moving beads on other beads, and chain forming of beads. The method is generic for a wide variety of biosensor systems (optical detection, magnetic detection, electrical detection, acoustic detection etc.). Using detection with other than magnetic methods, different targets for detection are designable. These targets are the target molecules, tags attached to the target molecules and/or attached to the magnetic beads, or preferably the magnetic beads. The magnetic beads are in one variation detected by optical means.

In a further development, a bead movement can be realized by a plurality of wires, wherein the wire-current and wire-voltage are actuated in time multiplex (e.g. like a N-phase linear motor acting as a conveyor belt).

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. Microelectronic device (100, 200, 300, 400, 500) for manipulating a sample, comprising
a) a sample chamber (10);
b) at least one electrode, called B/E-electrode (21, 22);
c) a control circuit (41, 42, 43, 44) that is coupled to said B/E-electrode (21, 22) and adapted to control it selectively in
(i) a “magnetizing mode” in which it generates a magnetic field (B) in the sample chamber (10), and
(ii) an “electrical mode” in which it generates an electrical field (E) in the sample chamber (10).

2. The microelectronic device (100, 200, 300, 400, 500) according to claim 1, characterized in that it comprises at least one second electrode, called E-electrode (21, 22, 23, 24), and that the B/E-electrode (21, 22) generates the electrical field (E) in the electrical mode cooperatively with said E-electrode.

3. The microelectronic device (100, 200, 300, 400, 500) according to claim 1, characterized in that it comprises at least one magnetic sensor element for detecting magnetic fields originating in the sample chamber (10), particularly a Hall sensor or a magneto-resistive element (31) like a GMR, a TMR, or an AMR element.

4. The microelectronic device (100, 200, 300, 400, 500) according to claim 1, characterized in that the magnetizing mode and the electrical mode can be executed simultaneously.

5. The microelectronic device (100, 200, 300, 400, 500) according to claim 1, characterized in that the gradient of the electrical field (E) and/or of the magnetic field (B) is non-zero at least somewhere inside the sample chamber (10).

6. The microelectronic device (100, 200, 300, 400, 500) according to claim 1, characterized in that the electrical field (E) generated in the electrical mode is capable of inducing flow in a fluid and/or a movement of particles in the sample chamber (10).

7. The microelectronic device (100, 200, 300, 400, 500) according to claim 2, characterized in that the E-electrode (21, 22) can be operated as a B/E-electrode.

8. The microelectronic device (100, 200, 300, 400, 500) according to claim 1, characterized in that it comprises an array of processing units, each processing unit comprising at least one B/E-electrode (21, 22).

9. The microelectronic device according to claim 8, characterized in that each B/E-electrode of the processing units may also serve as counter electrode for another B/E electrode in the electrical mode thereof.

10. The microelectronic device (100, 200, 300, 400, 500) according to claim 1, characterized in that the control circuit comprises at least one switch (41) for selectively coupling the B/E-electrode (21, 22) to different power supplies, particularly to a current source (43) and a voltage source (42).

11. The microelectronic device (400) according to claim 1, characterized in that the B/E-electrode (21, 22) and a dummy resistance (R) are connected in parallel to a current source (43) and that the control circuit comprises at least one switch (41) for selectively closing the circuit to the current source (43) via the B/E-electrode (21, 22) or the dummy resistance (R).

12. The microelectronic device (200, 300) according to claim 2, characterized in that it comprises at least one E-electrode (23, 24) that cannot be operated as a B/E-electrode.

13. The microelectronic device (200, 300) according to claim 2, characterized in that it comprises at least two additional E-electrodes (23, 24) and that the control circuit is adapted to control them in an “additional electrical mode” such that they generate cooperatively an electrical field (E) in the sample chamber (10).

14. The microelectronic device (300) according to claim 1, characterized in that the sample chamber (10) comprises a buffer region (13) that is substantially out of the reach of the magnetic field (B) generated by the B/E-electrode (21, 22).

15. The microelectronic device (300) according to claim 14, characterized in that it comprises additional electrodes (23, 24) for generating, alone or in cooperation with the B/E-electrode (21, 22), an electrical field in the buffer region (13).

16. The microelectronic device (100, 200, 300, 400, 500) according to claim 2, characterized in that the distance between the B/E-electrode (21, 22) and the E-electrode (23, 24) and/or between several E-electrodes (23, 24) is less than 200 μm, preferably less than 50 μm.

17. The microelectronic device (100, 200, 300, 400, 500) according to claim 1, characterized in that the B/E-electrode (21, 22) and/or the E-electrode (23, 24) are separated from the sample chamber (10) by a dielectric layer.

18. The microelectronic device (100, 200, 300, 400, 500) according to claim 1, characterized in that it comprises a receiver for a wireless power supply.

19. A method for the manipulation of a sample in a sample chamber (10), comprising:
a) the generation of a magnetic field (B) in the sample chamber (10) by applying a current to at least one electrode, called B/E-electrode (21, 22);
b) the generation of an electrical field (E) in the sample chamber (10) by applying an electrical potential to said B/E-electrode (21, 22).

20. The method according to claim 19,
characterized in that a voltage is applied between the B/E-electrode (21, 22) and a second electrode, called E-electrode (23, 24).

21. The method according to claim 19,
characterized in that the sample comprises a fluid, preferably a fluid with magnetic particles (11).

22. Use of the microelectronic device (100, 200, 300, 400, 500) according to claim 1 for molecular diagnostics, biological sample analysis, or chemical sample analysis.
